(19) United States
(12) Patent Application Publication
(10) Pub. No.: US 2007/0027655 A1
(43) Pub. Date: Feb. 1, 2007

(54) Aircraft component condition monitoring system based on electronic serialisation

(76) Inventor: Dennis E. Schmidt, San Diego, CA (US)

Correspondence Address: Hamilton Sundstrand, 4747 Harrison Ave, P.O. Box 7002, Rockford, IL, 61125, US

(21) Appl. No.: 11/190,180

(22) Filed: Jul. 26, 2005

(51) Int. Cl. G06F 11/00; G06F 15/00

(52) U.S. Cl. 702/188

(57) ABSTRACT

A condition monitoring system for an aeronautical power system with an electronic data collection system that lets components of the aeronautical power system identify themselves over a single wire data bus and transfers identification data received over the single wire data bus to a health monitoring system for analysis of the aeronautical system components.

### FIELD OF THE INVENTION

The invention relates to electrical system health and prognostics systems, and more particularly to condition monitoring for aeronautical components such as power systems.

### BACKGROUND OF THE INVENTION

Current condition monitoring systems for aircraft components typically require information provided by some maintenance action, such as logging hours and/or cycles of a particular component and/or system or information related to the removal of a component or components. This information requires human interaction to retrieve and provide this information, such as component part number, serial number, reason for removal, and so forth by way of manual methods of communication, such as handwritten maintenance logs, computer data entry, and so forth.

Often times this data is erroneous, incomplete or missing altogether. The effort to track data such as hours or cycles of use for multiple components is too great to justify the manpower required to ascertain it. This problem is most significant for those components that do not have any means of self-identification, such as electronic serialisation. Lack of self-identification of such components precludes electronic interrogation systems from remotely interrogating and transmitting their data.

For instance, line replaceable units (LRUs) such as an electric generator, starter motor, fuel control unit (FCU), oil pump, data memory module and exciter may be associated with an aeronautical auxiliary power unit (APU). One conventional aircraft component monitoring system proposes the use of LRUs that have special programmable memory chips that contain data such as the LRU serial number, part number, as-built performance and other pertinent data. A special smart data memory module (SDMM) interrogates the memory chip for each LRU. The SDMM stores this data and communicates the stored data to an electronic control unit (ECU). The ECU keeps track of LRU usage with the communicated data to predict performance and failure of each LRU. The ECU communicates accumulated LRU usage, predicted performance and failure information back to the SDMM. The SDMM then programs each LRU memory chip with this information to provide a history of operation and failure in each LRU memory chip. See U.S. Pat. No. 6,845,306 to Henry et al.

Although this approach is useful in monitoring and predicting performance and failures of LRUs in APU applications, the use of programmable memory chips in LRUs is often impractical or unreasonably costly because of ambient temperature fluctuations to which the LRUs are exposed. Programmable memory that can withstand such temperature variations is expensive. Furthermore, the use of a special SDMM for interrogating and programming such LRU memory modules and storing their data is an additional expense as well as weight and volume increase to the APU system.

### SUMMARY OF THE INVENTION

The invention comprises a condition monitoring system for an aeronautical power system that let components of the aeronautical power system to identify themselves over a single wire data bus and transfer identification data received over the single wire data bus to a ground-based health monitoring system for analysis of the aeronautical system components. More specifically, the invention adds an inexpensive, off-the-shelf 1-wire device to each line-replaceable unit (LRU) aboard an aircraft. Each 1-wire device has a unique as-built electronic serial number. An on-board data collection system within an electronic control unit (ECU) interrogates each LRU 1-wire device to collect LRU 1-wire device serial number data and transmits the serial number data to a heath monitoring system that automatically correlates the serial number data with stored LRU data to identify each LRU. The health monitoring system is typically ground-based and it receives the transmitted data from the on-board data collection system by way of a communication channel link. The health monitoring system tracks the component hours or cycles, removals and as-flown configuration of each identified LRU. Algorithms and other data may be contained in the ground-based heath monitoring system to determine health as well as prognostic and diagnostic information.

For an aeronautical power system that comprises a plurality of line replaceable units (LRUs) for the aeronautical power system and an electronic control unit (ECU) for controlling the aeronautical power system, a condition monitoring system a preferred embodiment of the invention comprises: an electronic data collection system that comprises a 1-wire device integrated within each LRU with unique non-programmable ROM serial number data; a single wire data line for coupling the LRU 1-wire devices together; and a 1-wire bus master connected to the single wire data line for collecting the serial number data from each LRU 1-wire device; and a health monitoring system for receiving data from the airborne electronic data collection system that comprises the serial number data and correlating each received ROM serial number with a stored cross-reference table of ROM serial number and LRU information to identify each LRU that is actually on board the aircraft.

### BRIEF DESCRIPTION OF THE DRAWINGS

FIG. 1 is a schematic block diagram of a 1-wire on-board data collection system for an aircraft component condition monitoring system according to a preferred embodiment of the invention as applied to an APU.

FIG. 2 is a schematic block diagram of an air-to-ground communications and data processing system for an aircraft component condition monitory system according to a preferred embodiment of the invention.

### DETAILED DESCRIPTION OF THE INVENTION

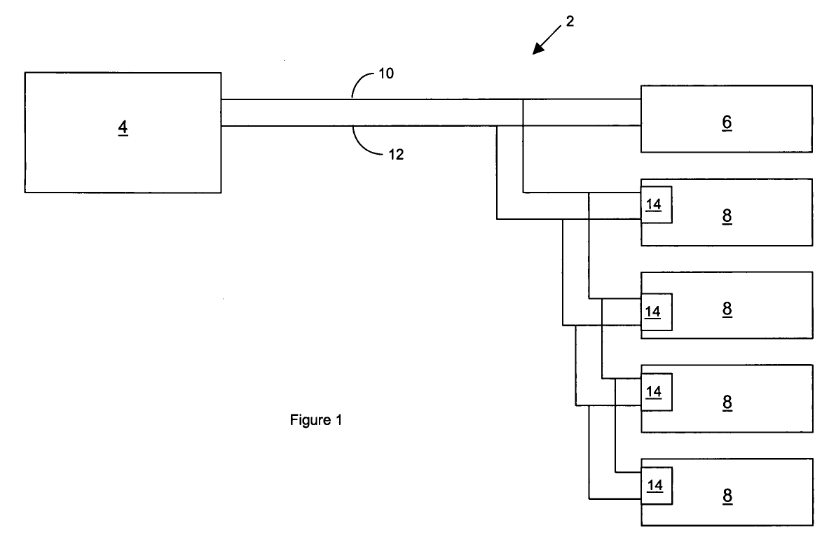

FIG. 1 shows an electronic data collection system 2 for a component such as an aeronautical APU according to the invention. The data collection system 2 comprises a an auxiliary power unit controller (APUC) or electronic control unit (ECU) 4 that couples to a dynamic memory module (DMM) 6 and a plurality of APU LRUs 8 by way of a 1-wire data line 10 and return line or ground 12. The DMM 6, which may be an LRU itself, is a 1-wire programmable memory module such as a Dallas Semiconductor DS2430A 256-bit 1-wire EEPROM. The DMM 6 interfaces with the ECU 4 in a conventional manner, storing information that the ECU 4 transfers to it such as the serial number, performance and failure data, hours and cycles and as-flown configuration of the APU. Each LRU 8 has an associated LRU 1-wire device 14, such as a Dallas Semiconductor DS18S20. The 1-wire DMM 6 and LRU 1-wire devices 14 have a unique identifier, such as a laser-fabricated non-erasable read-only memory (ROM) 64-bit code, including a 48-bit serial number, that may be used to identify them. Although the DS18S20 is actually a 1-wire digital thermometer, the identification process only uses the serial number data from each LRU 1-wire device 14. However, the ECU 4 may optionally collect temperature data from each LRU 1-wire device 14 that is representative of temperature data for its respective LRU 8.

In operation, at power-up the ECU 4 begins an initialisation sequence that comprises a reset pulse generated by a 1-wire bus master in the ECU 4 transmitted to the DMM 6 and each LRU 1-wire device 14 on the data line followed by presence pulses transmitted by the DMM 6 and each LRU 1-wire device 14 to the 1-wire bus master of the ECU 4 that indicate they are active and ready to operate. The 1-wire bus master of the ECU 4 then initiates a search ROM cycle that causes the DMM 6 and each LRU 1-wire device 14 to identify itself by transmitting its afore-mentioned serial number data to the ECU 4.

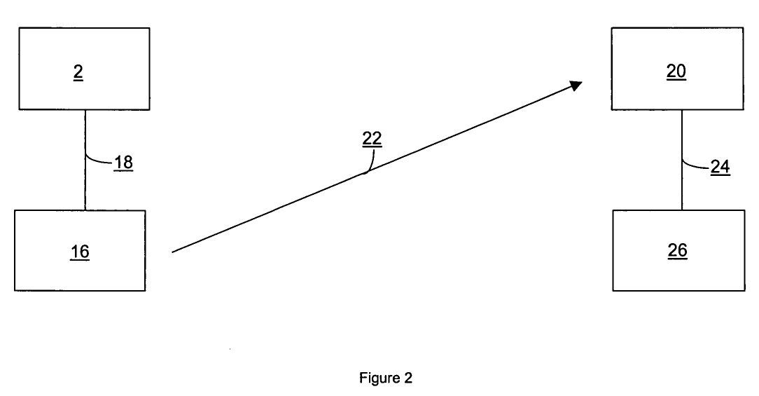

Referring to FIG. 2, the electronic data collection system 2 then transmits the serial number data collected by the ECU 4, along with separately collected fault and condition monitoring data, to an on-board aircraft communication system, such as an addressing report system (ACARS) transmitter 16 by way of a data link 18. The on-board ACARS transmitter 16 relays this data to a ground-based ACARS receiver 20 by way of an electromagnetic radiation signal path 22. Typically, the on-board transmitter 16 transmits serial number data upon any change in serial number data, fault data upon any fault occurrence and condition monitoring data every nth start-up, wherein n is a preselected number. The receiver 20 transfers this data by way of a data link 24 to a ground-based health monitoring system 26 that evaluates the received data. Alternatively, the health monitoring system 26 may be placed on-board, in which case the electronic data collection system 2 transmits the serial number data collected by the ECU 4, along with separately collected fault and condition monitoring data directly to the health monitoring system 26 by way of a suitable data bus.

The health monitoring system 26 correlates each received ROM serial number with a stored cross-reference table of ROM serial number and LRU information to identify the LRUs actually on board the aircraft. The health monitoring system 26 could be any suitable general purpose computer. Once identified, the health monitoring system 26 correlates the identified DMM 6 and each identified LRU 8 with stored hours or cycles of use information and adds received hours or cycles of use information to the stored information to predict mean time before unscheduled removal (MBTUR) for the DMM 6 and each LRU 8. The health monitoring system 26 also may provide fault history based on stored and received fault data and LRU removal history to aid in testing and logistics. Received condition monitoring data may be used to track APU service bulletin incorporation and to aid in troubleshooting.

Having real-time data for LRU hours or cycles of operation, faults and condition monitoring data allows the health monitoring system 26 to quickly and accurately predict the condition and performance of the APU as well as the individual DMM 6 and LRUs 8 as well and performance trending with suitable algorithms. This information may be used to minimise troubleshooting time and the number of unavailable APUs and to improve inventory management based on real-time knowledge of LRU removal and configuration. Performance trending allows any adverse trends that are detected to be identified and resolved before becoming a significant issue, thereby providing a proactive approach to problem solving that improves MTBUR of the APU system.

A major advantage of condition monitoring according to the invention is that multiple LRUs for an aircraft system that have small and inexpensive off-the-shelf 1-wire devices integrated therein identify themselves over a single wire communications data bus so that a health monitoring system may keep track of hours and cycles of the LRUs to aid in determining the performance and life of the LRUs. Described above is a condition monitoring system for an aeronautical power system with an electronic data collection system that lets components of the aeronautical power system identify themselves over a single wire data bus and transfers identification data received over the single wire data bus to a health monitoring system for analysis of the aeronautical system components. It should be understood that this described embodiment is only an illustrative implementation of the invention as applied to an APU, that the various parts and arrangement thereof may be changed or substituted, and that the invention is only limited by the scope of the attached claims.

What is claimed is:

1. For a system that comprises a plurality of replaceable units and an electronic control unit (ECU) for controlling the system, a condition monitoring system comprising:
an electronic data collection system that comprises a 1-wire device integrated within each replaceable unit with unique non-programmable ROM serial number data; a single wire data line for coupling the replaceable unit 1-wire devices together; and a 1-wire bus master connected to the single wire data line for collecting the serial number data from each replaceable unit 1-wire device; and
a health monitoring system for receiving data from the electronic data collection system that comprises the serial number data and correlating each received ROM serial number with a stored cross-reference table of ROM serial number and replaceable unit information to identify each replaceable unit that is actually on the system.

2. The condition monitoring system of claim 1, wherein said replaceable units are line replaceable units (LRUs).

3. The condition monitoring system of claim 1, wherein the electronic data collection system is on-board and the health monitoring system is ground based, further comprising:
an on-board aircraft communication addressing report system (ACARS) transmitter that transmits data from the electronic data collection system; and
a ground based ACARS receiver that transmits data received from the ACARS transmitter to the ground-based health monitoring system.

4. The condition monitoring system of claim 1, wherein the electronic data collection system collects serial number data, fault data and condition monitoring data from the ECU.

5. The condition monitoring system of claim 1, wherein the 1-wire bus master is in the ECU.

6. The condition monitoring system of claim 1, wherein the replaceable unit 1-wire devices send their respective serial number data on the single wire data line in response to a search ROM cycle that the 1-wire bus master initiates.

7. The condition monitoring system of claim 1, wherein the health monitoring system correlates each identified LRU with stored hours or cycles of use information and adds received hours or cycles of use information to the stored information to predict mean time before unscheduled removal (MBTUR) for each replaceable units.

8. The condition monitoring system of claim 7, wherein the health monitoring system provides a fault history based on stored and received fault data and replaceable removal history to aid in testing and logistics.

9. The condition monitoring system of claim 7, wherein the health monitoring system uses received condition monitoring data to track system service bulleting incorporation and to aid in troubleshooting.

10. The condition monitoring system of claim 1, wherein the system comprises an aeronautical auxiliary power unit (APU).

11. For an aeronautical power system that comprises a plurality of line replaceable units (LRUs) for the aeronautical power system and an electronic control unit (ECU) for controlling the aeronautical power system, a condition monitoring system comprising:
an electronic data collection system that collects serial number data, fault data and condition monitoring data from the ECU and comprises a 1-wire device integrated within each LRU with unique non-programmable ROM serial number data; a single wire data line for coupling the LRU 1-wire devices together; and a 1-wire bus master in the ECU that connects to the single wire data line for collecting the serial number data from each LRU 1-wire device; and
a health monitoring system for receiving data from the electronic data collection system that comprises serial number data, fault data and condition monitoring data and correlating each received ROM serial number with a stored cross-reference table of ROM serial number and LRU information to identify each LRU that is actually on board the aircraft.

12. The condition monitoring system of claim 11, wherein the LRU 1-wire devices send their respective serial number data on the single wire data line in response to a search ROM cycle that the 1-wire bus master initiates.

13. The condition monitoring system of claim 11, wherein the health monitoring system correlates each identified LRU with stored hours or cycles of use information and adds received hours or cycles of use information to the stored information to predict mean time before unscheduled removal (MBTUR) for each LRU.

14. The condition monitoring system of claim 13, wherein the health monitoring system provides a fault history based on stored and received fault data and LRU removal history to aid in testing and logistics.

15. The condition monitoring system of claim 13, wherein the health monitoring system uses received condition monitoring data to track aeronautical power system service bulleting incorporation and to aid in troubleshooting.

16. The condition monitoring system of claim 11, wherein the aeronautical power system comprises an auxiliary power unit (APU).

17. For an aeronautical auxiliary power unit (APU) that comprises a plurality of line replaceable units (LRUs) for the aeronautical power system and an electronic control unit (ECU) for controlling the APU, a condition monitoring system comprising:
an electronic data collection system that collects serial number data, fault data and condition monitoring data from the ECU and comprises a 1-wire device integrated within each LRU with unique non-programmable ROM serial number data; a single wire data line for coupling the LRU 1-wire devices together; and a 1-wire bus master in the ECU that connects to the single wire data line for collecting the serial number data from each LRU 1-wire device; and
a health monitoring system for receiving data from the electronic data collection system that comprises serial number data, fault data and condition monitoring data, correlating each received ROM serial number with a stored cross-reference table of ROM serial number and LRU information to identify each LRU that is actually on board the aircraft and correlating each identified LRU with stored hours or cycles of use information and adds received hours or cycles of use information to the stored information to predict mean time before unscheduled removal (MBTUR) for each LRU.

18. The condition monitoring system of claim 17, wherein the health monitoring system provides a fault history based on stored and received fault data and LRU removal history to aid in testing and logistics.

19. The condition monitoring system of claim 17, wherein the health monitoring system uses received condition monitoring data to track aeronautical power system service bulleting incorporation and to aid in troubleshooting.

20. An aeronautical power system, comprising:
a plurality of line replaceable units (LRUs);
an electronic control unit (ECU) for controlling the aeronautical power system;
an electronic data collection system that collects serial number data, fault data and condition monitoring data from the ECU and comprises a 1-wire device integrated within each LRU with unique non-programmable ROM serial number data;
a single wire data line for coupling the LRU 1-wire devices together; and
a 1-wire bus master in the ECU that connects to the single wire data line for collecting the serial number data from each LRU 1-wire device.
